(19) United States
(12) Patent Application Publication
(10) Pub. No.: US 2024/0380064 A1
(43) Pub. Date: Nov. 14, 2024

(54) BATTERY PACK

(71) Applicant: SK On Co., Ltd., Seoul (KR)

(72) Inventors: Jin Su HAN, Daejeon (KR); Min Song KANG, Daejeon (KR); Ji Woong KIM, Daejeon (KR); Byeong Jun PAK, Daejeon (KR); Ju Yong PARK, Daejeon (KR); Suk Ho SHIN, Daejeon (KR)

(21) Appl. No.: 18/659,013

(22) Filed: May 9, 2024

(30) Foreign Application Priority Data
May 11, 2023 (KR) 10-2023-0060806

(51) Int. Cl. H01M 50/358; H01M 50/204; H01M 50/383

(52) U.S. Cl. CPC H01M 50/358; H01M 50/204; H01M 50/383

(57) ABSTRACT

The present invention relates to a battery pack that may reduce risks caused by a large amount of gas. In addition, the present invention may provide a battery pack that discharges a gas but prevents internally generated flames from being exposed to the outside. In addition, the present invention may provide an electric device including one or more battery packs.

### CROSS-REFERENCE TO RELATED PATENT APPLICATION

The present application claims priority under 35 U.S.C. § 119 (a) to Korean patent application number 10-2023-0060806 filed on May 11, 2023, in the Korean Intellectual Property Office, the entire disclosure of which is incorporated by reference herein.

### BACKGROUND OF THE INVENTION

### 1. Field

This application relates to a battery pack. In addition, the present invention relates to applications of the battery pack.

### 2. Description of the Related Art

Recently, demand for mobile devices such as smartphones, tablet PCs, and wireless earphones is increasing. In addition, as the development of electric vehicles, energy storage batteries, robots, and satellites is in full swing, research is being actively conducted on high-performance secondary batteries allowing for repeated charging and discharging as an energy source.

Currently commercialized secondary batteries include nickel cadmium batteries, nickel hydrogen batteries, nickel zinc batteries, and lithium secondary batteries. Among these, lithium secondary batteries have almost no memory effect compared to nickel-based secondary batteries, allowing free charging and discharging and exhibiting very low self-discharge rates and high energy density.

Meanwhile, a battery pack may include one or more battery cell units and various control devices to control the battery cell units. The control devices may generally include a battery management system (BMS) and may further include a cooling system. Patent Document 1 may be referred to as an example of the battery pack.

In the battery pack, thermal runaway phenomenon may occur in a battery cell unit due to a mechanical abnormal condition, an electrical abnormal condition, a thermal abnormal condition, or an internal short circuit. Before the thermal runaway phenomenon occurs, a large amount of gas is generated from the battery cell unit. When the inside of the battery pack maintains high-pressure conditions because the large amount of gas may not be discharged to the outside, an explosion or a larger fire may occur due to a high-voltage short circuit.

### SUMMARY OF THE INVENTION

One object of the present invention is to provide a battery pack that can prevent risks caused by a large amount of gas. In addition, another object of the present invention is to provide a battery pack that discharges a gas but prevents internally generated flames from being exposed to the outside. In addition, still another object of the present invention is to provide an electric device including one or more battery packs.

Meanwhile, a battery pack according to the present disclosure can be widely applied in the field of electric vehicles, battery charging stations, energy storage system (ESS), and green technology such as photovoltaics and wind power generation using batteries. In addition, a battery pack according to the present disclosure can be used in eco-friendly mobility, including electric vehicles and hybrid vehicles, to prevent climate change by suppressing air pollution and greenhouse gas emissions.

A battery pack according to one embodiment of the present invention may include: one or more battery cell units; a frame portion including an outer frame surrounding an inner space in which the battery cell units are installed; and an extension unit provided at a partial area of the frame portion, wherein the outer frame includes a support frame, an inner passage which is formed by being surrounded by the support frame and through which a gas may pass; and a communication hole communicating the inner passage and the outside of the outer frame, and the extension unit includes an extension frame and an extension passage through which the gas may pass, wherein the extension passage which is formed by being surrounded by the extension frame and which is in communication with the internal passage with each other.

A battery pack according to one embodiment of the present invention may satisfy Mathematical Formula 1 below:

$$T \leq {T}_{A} \qquad [ Mathematical Formula 1 ]$$

In Mathematical Formula 1, T refers to the temperature (unit: ° C.) measured in the communication hole when the temperature (T_{I}) of the battery cell unit is 200° C. or higher, and TA refers to 800° C. as a reference temperature.

In a battery pack according to one embodiment of the present invention, the temperature (Ti) of the battery cell unit may be 200° C. or higher, and a ratio (T/T_{I}) of the temperature (T, unit: ° C.) measured in the communication hole to the temperature of the battery cell unit (T_{I}, unit: ° C.) may be within a range of 0.1 to 0.7.

In a battery pack according to one embodiment of the present invention, the extension unit may be provided at a partial area of the outer frame.

In a battery pack according to one embodiment of the present invention, the extension unit may further include a first access passage and a second access passage formed such that the extension passage and the inner passage communicate with each other, wherein the first access passage and the second access passage face each other, and the first extension satisfies Mathematical Formula 2 below:

$${L}_{G} > {L}_{U} \qquad [ Mathematical Formula 2 ]$$

In Mathematical Formula 2, L_{U} refers to the straight line distance between the first access passage and the second access passage, and L_{G} refers to the length of the extension passage.

In a battery pack according to one embodiment of the present invention, the extension unit may further include one or more partition walls, wherein the partition wall is connected to the extension frame and disrupts passing of a gas.

In a battery pack according to one embodiment of the present invention, the extension unit may further include a plurality of partition walls.

In a battery pack according to one embodiment of the present invention, the extension unit may be coupled and fixed to the frame portion.

In a battery pack according to one embodiment of the present invention, the extension unis may include a material with a melting point of 550° C. or higher.

In a battery pack according to one embodiment of the present invention, at least a part of the battery cell unit may be in contact with the outer frame, and at least a part of the contacted area of the battery cell unit and the outer frame may include a discharge hole in communication with the inner passage, and a gas generated from the battery cell unit may flow into the inner passage through the discharge hole.

In a battery pack according to one embodiment of the present invention, the extension unit may be positioned at an area between a communication hole (H₁) and an adjacent discharge hole (H₂), which is a discharge hole positioned closest to the communication hole along the internal passage.

In a battery pack according to one embodiment of the present invention, the extension unit may satisfy Mathematical Formula 3 below:

$${L}_{2} > {L}_{1} \qquad [ Mathematical Formula 3 ]$$

In Mathematical Formula 3, L₁ refers to the distance along the internal passage between the extension unit and the communication hole (H₁), and L₂ refers to the distance along the internal passage between the extension unit and the adjacent discharge hole (H₂).

In a battery pack according to one embodiment of the present invention, the frame portion may further include one or more cross members crossing the inner space, and at least a part of the battery cell unit is in contact with the cross member.

In a battery pack according to one embodiment of the present invention, the cross member may be coupled and fixed to the outer frame, wherein the cross member includes a support member and a cross passage which formed by being surrounded by the support member and through which a gas may pass, wherein at least a part of the area in which the battery cell unit may be in contact with the cross member includes a discharge hole in communication with the cross passage, and wherein a gas generated from the battery cell unit may flow into the cross passage through the discharge hole.

In a battery pack according to one embodiment of the present invention, the inner passage of the outer frame may be in communication with the cross passage of the cross member with each other.

A battery pack according to one embodiment of the present invention may further include a sealing material, wherein the sealing material is positioned at an area in which the extension unit and the frame portion are coupled with each other.

An electric device according to one embodiment of the present invention may include one or more battery packs, wherein the battery pack may include a battery pack according to one embodiment of the present invention.

The present invention may provide a battery pack that can prevent risks caused by a large amount of gas. In addition, the present invention may provide a battery pack that discharges a gas but prevents internally generated flames from being exposed to the outside. In addition, the present invention may provide an electric device including one or more battery packs.

### BRIEF DESCRIPTION OF THE DRAWINGS

FIG. 1 is a diagram briefly showing a cross-section of a battery pack according to one embodiment of the present invention.

FIG. 2 is a diagram briefly showing an outer frame of a battery pack according to one embodiment of the present invention.

FIG. 3 is a diagram briefly showing an extension unit of a battery pack according to one embodiment of the present invention.

FIG. 4 is a diagram briefly showing an outer frame and an extension unit of a battery pack according to one embodiment of the present invention.

FIG. 5 is a diagram briefly showing an outer frame and an extension unit of a battery pack according to one embodiment of the present invention.

FIG. 6 shows a cross-section taken along line AA′ in FIG. 5 and is a diagram briefly showing an outer frame and an extension unit of a battery pack according to one embodiment of the present invention.

FIG. 7 shows an example different from FIG. 6 and is a diagram briefly showing an outer frame and an extension unit of a battery pack according to one embodiment of the present invention.

FIG. 8 is a diagram briefly showing a cross-section of a battery pack according to one embodiment of the present invention.

FIG. 9 is a diagram briefly showing a part of a cross-section of a battery pack according to one embodiment of the present invention.

### DETAILED DESCRIPTION

The structural or functional descriptions of embodiments disclosed in the present application are merely illustrated for the purpose of explaining embodiments according to the technical principle of the present invention, and embodiments according to the technical principle of the present invention may be implemented in various forms in addition to the embodiments disclosed in the present application. In addition, the technical principle of the present invention is not construed as being limited to the embodiments described in the present application.

Among the physical properties mentioned in the present application, in cases where the measurement temperature affects the physical properties, unless otherwise specified, the physical properties are the physical properties measured at room temperature and normal pressure.

The term ‘room temperature,’ as used in the present application, is a natural temperature that is not heated or cooled, and it may refer to, for example, any temperature in the range of 10° C. to 30° C., for example, about 15° C. or higher, about 18° C. or higher, about 20° C. or higher, about 23° C. or higher, about 27° C. or lower, or 25° C. Unless otherwise specified in the application, the unit of temperature is Celsius (° C.).

Among the physical properties mentioned in the present application, in cases where the measurement pressure affects the physical properties, unless otherwise specified, the physical properties are the physical properties measured at normal pressure.

The term ‘normal pressure,’ as used in the present application, is a natural pressure that is not pressurized or depressurized, and an atmospheric pressure in the range of about 700 mmHg to 800 mmHg is typically referred to as normal pressure.

The term ‘a to b,’ as used in the present application, includes within the range between a and b including a and b. For example, including a to b parts by weight has the same meaning as including within the range of a to b parts by weight.

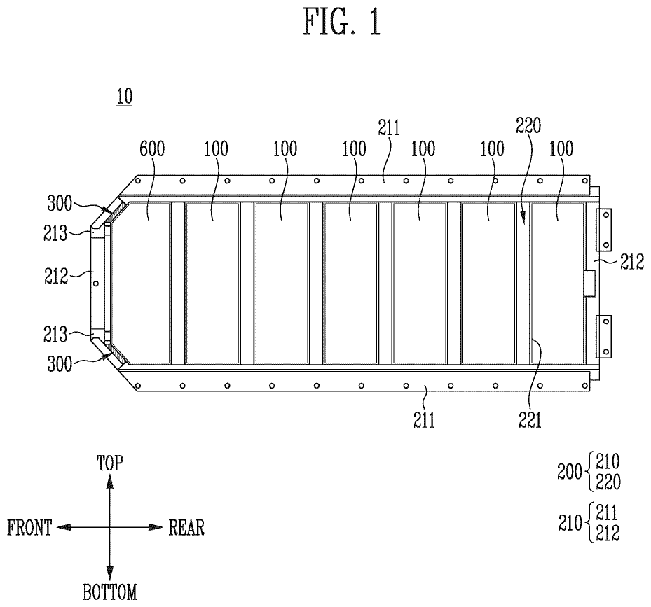

The present invention may provide a battery pack 10 that can prevent risks caused by a large amount of gas G (see FIG. 1). In addition, the present invention may provide a battery pack 10 that discharges a gas G but prevents internally generated flames from being exposed to the outside. In addition, the present invention may provide an electric device including one or more battery packs 10. The gas G may be generated in the battery cell unit 100 due to a thermal runaway phenomenon.

FIG. 1 is a diagram briefly showing a cross-section of a battery pack according to one embodiment of the present invention. Referring to FIG. 1, a battery pack 10 according to one embodiment of the present invention may include one or more battery cell units 100. In addition, the battery pack 10 may include a plurality of battery cell units 100. The battery cell unit 100 may include one or more battery cells, or may include a plurality of battery cells. In addition, the battery cell unit 100 may be a collection of battery cells, or may be a so-called battery module in which the collected battery cells are placed in a housing. Patent Document 2 discloses an example of a battery module. In addition, a plurality of battery cell units 100 may be electrically connected to each other in series, in parallel, or a combination thereof. In addition, within the battery cell unit 100, a plurality of battery cells may be electrically connected to each other in series, in parallel, or a combination thereof

The term ‘electrically connected,’ as used in the present application, may refer to a state in which an electric circuit is formed when connected objects are connected by a connecting means, and an electric current may flow to each connected object. The connecting means is not particularly limited as long as electrical connection is possible, but may be direct contact between connected objects or a wire through which a current may flow.

In the battery pack 10, a battery cell unit 100 may be seated on a plate (not shown). The plate may have a flat shape and may include a metal material, and the metal material may include aluminum. A frame portion 200, which will be described later, may also be seated on the plate. The frame portion 200 may be connected while being seated on the plate. In addition, the frame portion 200 may include a female thread hole to be connected to the plate, and the plate may include a hole at a position corresponding to the female thread hole so that a male thread passes through the plate and is inserted into the female thread hole. Alternatively, the frame parts 200 may be connected to the plate through an adhesive or welding. Specifically, the frame portion 200, which will be described later, may be connected to an outer frame 210 and a cross member 220 while being seated on the plate, and the connection method is the same as described above.

Although not shown in FIG. 1, the battery pack 10 may further include a cover portion (not shown) to protect a surface facing a surface seated on the plate. The cover portion may be connected to at least a part of the frame portion 200. In addition, in order that the cover portion and the frame portion 200 are connected, the cover portion and the frame portion 200 may include holes at appropriate positions corresponding to each other (for coupling with bolts and nuts), or the cover portion and the frame portion 200 may be connected to each other through an adhesive or welding.

Referring to FIG. 1, the battery pack 10 according to one embodiment of the present invention may include a control device 600. The control device 600 may include a battery management system (BMS) and may further include a cooling system. In addition, the control device 600 may be electrically connected to one or more installed battery cell units 100, and the state and function of the battery cell units 100 may be controlled by the control device 600. As a control method, a method known in the art may be applied.

Referring to FIG. 1, the battery pack 10 according to one embodiment of the present invention may include a frame portion 200. The frame portion 200 may include an outer frame 210. In addition, the outer frame 210 may surround an inner space where a battery cell unit 100 is installed. Referring to FIG. 1, the portion space may be determined according to the shape of the outer frame 210 of the frame unit 200. The shape of the frame portion 200 may be determined in consideration of the battery cell unit 100 and the control device 600.

Referring to FIG. 1, an outer frame 210 may include a pair of first frames 211 in parallel with a first direction and a pair of second frames 212 in parallel with a second direction, and the first direction may be perpendicular to the second direction. The first frame 211 and the second frame 212 may be directly or indirectly connected to each other. The first frame 211 and the second frame 212 include holes at appropriate positions corresponding to each other, and may be directly connected to each other through bolts and nuts. In addition, the first frame 211 and the second frame 212 may be directly connected through an adhesive or welding. Additionally, the first frame 211 and the second frame 212 may be indirectly connected through another component. A component may be connected to a first frame 211 and a second frame 212 to indirectly connect the first frame 211 and the second frame 212. In addition, when the first frame 211 and the second frame 212 are connected to each other, an inner space in which a battery cell unit 100 may be installed may be formed. In other words, the outer frame 210 may surround an inner space in which a battery cell unit 100 is installed.

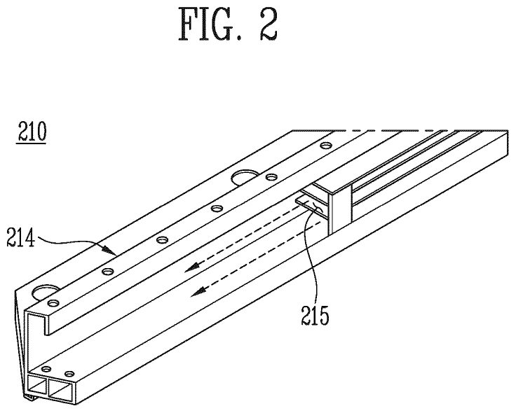

FIG. 2 is a diagram briefly showing an outer frame of a battery pack according to one embodiment of the present invention. Referring to FIG. 2, in a battery pack 10 according to one embodiment of the present invention, an outer frame 210 may include a support frame 214 and an inner passage 215. The inner passage 215 may be formed by being surrounded by the support frame 214 and allow a gas G to pass therethrough. In addition, referring to FIG. 1, in a battery pack 10 according to one embodiment of the present invention, an outer frame 210 may include a communication hole 213. The communication hole 213 may communicate the inner passage 215 and the outside of the outer frame 210.

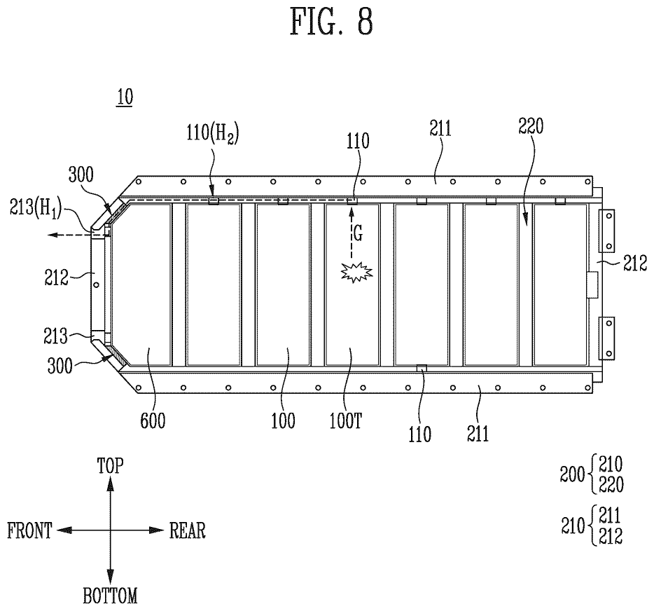

Referring to FIG. 2, an outer frame 210 of the battery pack 10 may include a support frame 214 and an inner passage 215. The support frame 214 may include a metal material, and the metal material may include aluminum. In addition, the support frame 214 may have a structure which determines the shape of an outer frame 210 and in which an empty space is formed inside the outer frame 210. Referring to FIG. 2, the support frame 214 may form an inner passage 215 through which a gas G may pass. In other words, the inner passage 215 may be formed by being surrounded by a support frame 214. The shape of the inner passage 215 is not particularly limited, and may be designed in various ways as needed. The shape of the internal passage 215 may be determined by the shape of the support frame 214. Not only a gas G but also particles may pass through the inner passage 215. Here, the particles that may pass through the inner passage 215 may refer to a solid state material having a size (particle diameter) that may pass through a discharge hole 110 (see FIG. 8), which will be described later.

Referring to FIG. 1, in the battery pack 10, at least a part of a battery cell unit 100 may be in contact with the outer frame 210. Referring to FIG. 1, in the battery pack 10, both an upper surface and a lower surface of a battery cell unit 100 are in contact with a first frame 211, the control device 600 is additionally in contact with a second frame 212 positioned on the front surface, and a battery cell unit 100 positioned farthest from the control device 600 is additionally in contact with a second frame 212 positioned in the rear surface.

In addition, referring to FIG. 1, in the battery pack 10, a frame portion 200 may further include one or more cross members 220 crossing an internal space. The cross member 220 may be parallel to a first direction or parallel to a second direction. In addition, the frame portion 200 may include a cross member 220 parallel to a first direction while crossing an inner space and a cross member 220 parallel to a second direction. Referring to FIG. 1, a plurality of cross members 220 may be provided and may be disposed in parallel with a second direction. The cross member 220 may partition between the battery cell units 100 or partition between a battery cell unis 100 and a control device 600. The cross member 220 may include a metal material, and the metal material may include aluminum. Referring to FIG. 1, in the battery pack 10, at least a part of the battery cell unit 100 may be in contact with a cross member 220. Referring to FIG. 1, in the battery pack 10, the front surface, the rear surface, or the front and rear surfaces of the battery cell unit 100 are in contact with the cross member 220.

In the battery pack 10 according to an embodiment of the present invention, a cross member 220 may be connected to an outer frame 210. The cross member 220 and the outer frame 210 may be in contact with each other or may include holes at appropriate positions corresponding to each other to be connected with bolts and nuts at the holes. In addition, the cross member 220 and the outer frame 210 may be connected through an adhesive or welding. In addition, the cross member 220 may be coupled and fixed to the outer frame 210. Here, being coupled and fixed may mean being connected and fixed while in contact with each other.

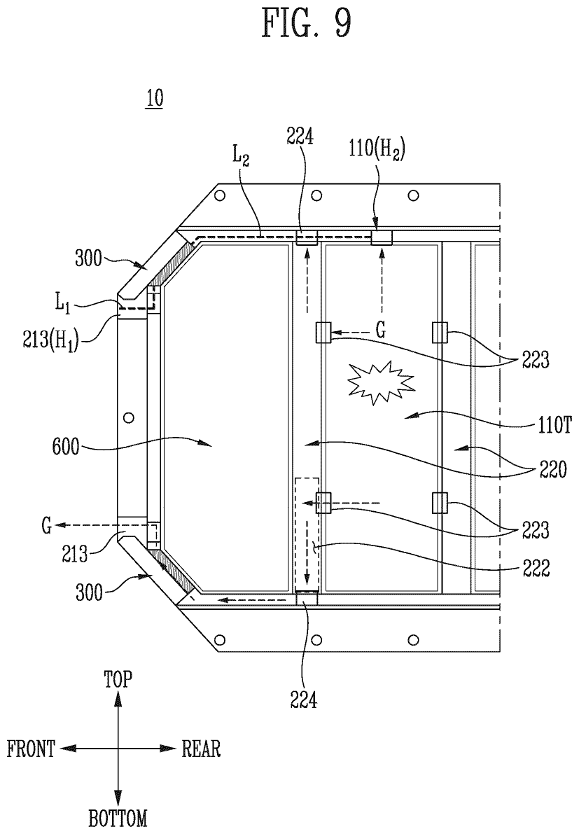

Referring to FIG. 1, a cross member 220 of the battery pack 10 may include a support member 221 and a cross passage 222 (see FIG. 9). The support member 221 may include a metal material, and the metal material may include aluminum. In addition, the support frame 214 may have a structure which determines the shape of a cross member 220 and in which an empty space is formed inside the cross member 220. The support frame 214 may form a cross passage 222 through which a gas G may pass. In other words, the cross passage 222 may be formed by being surrounded by a support frame 214. The shape of the cross passage 222 is not particularly limited, and may be designed in various ways as needed. The shape of cross passage 222 may be determined by the shape of the support frame 214. Not only a gas G but also particles may pass through the cross passage 222. Here, the particles that may pass through the cross passage 222 may refer to a solid state material having a size (particle diameter) that may pass through a discharge hole 223 (see FIG. 9), which will be described later.

In a battery pack 10 according to one embodiment of the present invention, at least a part of the battery cell unit 100 may be in contact with the outer frame 210, and at least a part of the contacted area of the battery cell unit 100 and the outer frame 210 may include a discharge hole 110 in communication with an inner passage 215 of the outer frame 210. Specifically, the battery cell unit 100 may include a housing including a battery cell therein, and the housing may be provided with the discharge hole 110 described above. In addition, an outer frame 210 may include a hole at a position corresponding to a discharge hole 110 provided in the battery cell unit 100, so that a gas G generated from the battery cell unit 100 passes through the discharge hole 110. Through a discharge hole 110 provided in the battery cell unit 100 and a hole of the outer frame 210 provided at a position corresponding to the discharge hole 110, the battery cell unit 100 and the inner passage 215 may communicate with each other.

In addition, referring to FIG. 8, a battery pack 10 according to one embodiment of the present invention may include a plurality of battery cell units 100, and each of the battery cell units 100 may include a discharge hole 110 in communication with an inner passage 215 of an outer frame 210. In addition, each of the battery cell units 100 may include one or more discharge holes 110, and it may include one or more discharge holes 110 in a same direction and one or more discharge holes 110 in different directions. For example, in the battery pack 10, both an upper surface and a lower surface of each battery cell unit 100 may be in contact with a first frame 211, and each battery cell unit 100 may independently be provided with one or more discharge holes 110 in a part of an area in contact with the first frame 211 on an upper surface, a lower surface, or an upper surface and an lower surface. In the battery pack 10, a gas (G) generated from a battery cell unit 100 may flow into the inner passage 215 through the discharge hole 110.

In a battery pack 10 according to one embodiment of the present invention, at least a part of a battery cell unit 100 may be in contact with a cross member 220, and at least a part of the contacted area of the battery cell unit 100 and the outer frame 210 may include a discharge hole 223 in communication with a cross passage 222 of the cross member 220. Specifically, the battery cell unit 100 may include a housing including a battery cell therein, and the housing may be provided with the discharge hole 223 described above. In addition, a cross member 220 may include a hole at a position corresponding to a discharge hole 223 provided in the battery cell unit 100, so that a gas G generated from the battery cell unit 100 passes through the discharge hole 223 and flow into a cross passage 222. Through a discharge hole 223 provided in the battery cell unit 100 and a hole of a cross member 220 provided at a position corresponding to the discharge hole 223, the battery cell unit 100 and the cross passage 222 may communicate with each other (see FIG. 9).

In addition, referring to FIG. 8, a battery pack 10 according to one embodiment of the present invention may include a plurality of battery cell units 100, and each of the battery cell units 100 may include a discharge hole 223 in communication with a cross passage 222 of a cross member 220 (see FIG. 9). In addition, each of the battery cell units 100 may include one or more discharge holes 223, and it may include one or more discharge holes 223 in a same direction and one or more discharge holes 223 in different directions. For example, in the battery pack 10, both an upper surface and a lower surface of each battery cell unit 100 may be in contact with a cross member 220, and each battery cell unit 100 may independently be provided with one or more discharge holes 223 in a part of an area in contact with each of the cross members 220 on an upper surface, a lower surface, or an upper surface and an lower surface.

In the battery pack 10 according to one embodiment of the present invention, a cross member 220 may be connected to an outer frame 210, and an inner passage 215 of the outer frame 210 and a cross passage 222 of the cross member 220 may be connected to each other (see FIG. 9). Referring to FIG. 9, specifically, the cross member 220 and the outer frame 210 are connected, each includes a connection hole 224, and each connection hole 224 is provided at a position corresponding to each other so that an inner passage 215 and a cross passage 222 are in communication with each other. A gas G generated from the battery cell unit 100 may flow into a cross passage 222 of a cross member 220 through a discharge hole 223, and the gas G that has flowed into the cross passage 222 may flow into an inner passage 215 an outer frame 210 through a connection hole 224 (see FIG. 9).

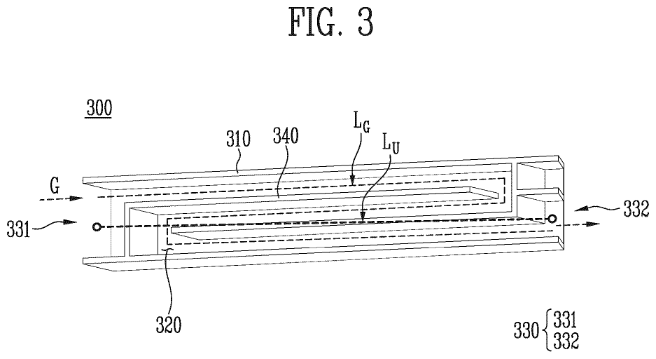

FIG. 3 is a diagram briefly showing an extension unit 300 of a battery pack 10 according to one embodiment of the present invention. Referring to FIGS. 1 and 3, a battery pack 10 according to one embodiment of the present invention may include an extension unit 300. The extension unit 300 may be provided at a partial area of a frame portion 200. The frame portion 200 may form an appropriate space so that an extension unit 300 may be provided. In addition, the extension unit 300 may be provided within an inner passage 215 formed by a frame portion 200 or may be provided at least inside a support frame 214. When the battery pack 10 includes an extension unit 300, risks caused by a large amount of gas G may be prevented, and a gas G may be discharged, but internally generated flames may be prevented from being exposed to the outside.

In a battery pack 10 according to one embodiment of the present invention, specifically, an extension unit 300 may be provided at a partial area of an outer frame 210 of a frame portion 200. Referring to FIG. 1, an extension unit 300 is provided at a partial area of an outer frame 210.

In addition, in FIG. 1, an extension unit 300 is provided at the front part of a battery pack 10, but in other examples, an extension unit may be provided at the rear part. In addition, in the battery pack 10, an extension unit 300 may be provided at a partial area of an outer frame 210 that is an area adjacent to a position where a communication hole 213 is provided. The position of the extension unit 300 is not particularly limited, and it may be provided at a partial area of an outer frame 210 in consideration of the position of a communication hole 213.

A battery pack 10 according to one embodiment of the present invention may satisfy Mathematical Formula 1 below. The battery pack 10 may satisfy Mathematical Formula 1 below by including the above-described extension unit 300.

$$T \leq {T}_{A} \qquad [ Mathematical Formula 1 ]$$

In Mathematical Formula 1, T refers to the temperature (unit: ° C.) measured in the communication hole 213 when the temperature (T_{I}) of the battery cell unit is 200° C. or higher, and TA refers to 800° C. as a reference temperature.

In the above, the temperature (T_{I}) of a battery cell unit 100 may be 200° C. or higher, 220° C. or higher, 240° C. or higher, 260° C. or higher, 280° C. or higher, 300° C. or higher, 350° C. or higher, 400° C. or higher, 450° C. or higher, or 500° C. or higher, or 1,500° C. or lower, 1,400° C. or lower, 1,300° C. or lower, 1,200° C. or lower, 1,100° C. or lower, 1,000° C. or lower, 950° C. or lower, 900° C. or lower, 850° C. or lower, 800° C. or lower, 750° C. or lower, or 700° C. or lower. In addition, the temperature (T_{I}) of the battery cell unit 100 may be known as a value measured by a temperature measurement device within a control device 600. Alternatively, the temperature may be measured directly on the battery cell unit 100 (for example, using an infrared thermometer, etc.). In addition, when the temperature (T_{I}) of the battery cell unit 100 is within the above-described range, it may be considered that a so-called thermal runaway phenomenon has occurred. In addition, when there are a plurality of battery cell units 100, the temperature (T_{I}) of the battery cell unit 100 may be measured based on the battery cell unit 100 that has first reached 200° C.

The TA may refer to a temperature lower than the temperature measured in the communication hole 213 in the absence of the extension unit 300 when a thermal runaway phenomenon occurs in a battery cell unit 100. In other words, the TA may be a reference temperature determining whether flames occur in a battery cell unit 100 due to a thermal runaway phenomenon and whether the flames are exposed to the outside. In other words, in cases where the temperature (T_{I}) of the battery cell unit 100 is 200° C. or higher, when T, the temperature measured in the communication hole 213, is lower than the TA, it may be said that the battery cell 10 prevents flames to be exposed to the outside.

As described above, when an outer frame 210 is extended in the absence of an extension unit 300, flames generated due to a thermal runaway phenomenon in the battery cell unit 100 may be exposed to the outside through the communication hole 213, and the temperature measured in the communication hole 213 may be within the range of about 900° C. to 1,000° C. due to the flame. The TA may be determined based on the temperature measured in the communication hole 213 when the flames are exposed. Considering this, the TA may be 790° C. or lower, 780° C. or lower, 770° C. or lower, 760° C. or lower, 750° C. or lower, 740° C. or lower, 730° C. or lower, 720° C. or lower, 710° C. or lower, 700° C. or lower, 690° C. or lower, 680° C. or lower, 670° C. or lower, 660° C. or lower, 650° C. or lower, 640° C. or lower, 630° C. or lower, 620° C. or lower, or 610° C. or lower.

In a battery pack 10 according to one embodiment of the present invention, the flames are prevented from being exposed to the outside by including an extension unit 300, and thus the temperature measured in the communication hole 213 may be lower than the temperature measured in the communication hole 213 in the absence of the extension unit 300. In other words, even when a thermal runaway phenomenon occurs, the temperature measured in the communication hole 213 may be lower than or equal to TA, which is a reference temperature, and this is defined by Mathematical Formula 1 above.

In addition, in the above, when it is assumed that there is a certain object in the form of the communication hole 213, the temperature (T) measured in the communication hole 213 may be with reference to a temperature measured at a point P corresponding to the center of gravity of the object.

In the battery pack 10 according to one embodiment of the present invention, the temperature (T_{I}) of the battery cell unit may be 200° C. or higher, and a ratio of the temperature (T, unit: ° C.) measured in the communication hole to the temperature of the battery cell unit (T_{I}, unit: ° C.) may be in the range of 0.1 to 0.7, 0.15 to 0.65, or 0.2 to 0.6. The battery pack 10 may control the temperature ratio (T/T_{I}) within the above-described range by including the above-described extension unit 300. In addition, when the temperature ratio (T/T_{I}) is within the above-described range, it may be considered that a gas G is discharged, but internally generated flames are not exposed to the outside. In addition, the battery pack 10 may prevent flames caused by a thermal runaway phenomenon from being exposed to the outside.

Referring to FIG. 3, in a battery pack 10 according to one embodiment of the present invention, an extension unit 300 may include an extension passage 320 through which a gas G may pass. In addition, the extension unit 300 may include an extension frame 310. The extension passage 320 may be formed be being surrounded by the extension frame 310, and it may allow a gas G to pass therethrough. In addition, referring to FIG. 3, an extension unit 300 may include an access passage 330, and it may include a partition wall 340 forming the extension passage 320.

In the battery pack 10 according to one embodiment of the present invention, an extension passage 320 of an extension unit 300 may be in communication with an inner passage 215 of an outer frame 210. As described above, the extension unit 300 may include an access passage 330 through which a gas G may flow in and out (see FIG. 3). Referring to FIG. 3, an inlet passage 330 of an extension unit 300 may allow an extension passage 320 and an inner passage 215 to communicate with each other.

Referring to FIG. 3, in a battery pack 10 according to one embodiment of the present invention, an extension unit 300 may include an access passage 330 so that the extension passage 320 and the inner passage 215 communicate with each other. The access passage 330 may include a first access passage 331 and a second access passage 332. In addition, referring to FIG. 3, the first access passage 331 and the second access passage 332 may face each other. When the first access passage 331 and the second access passage 332 face each other, it may be more advantageous when discharging a gas G but preventing internally generated flames from being exposed to the outside.

In a battery pack 10 according to one embodiment of the present invention, the length of an extension passage 320 may be longer than the length of a long side of an extension unit 300. The long side may refer to a longest side. By making the length of the extension passage 320 longer than the length of the long side of the extension unit 300, it may be more advantageous when discharging a gas G but preventing internally generated flames from being exposed to the outside.

In a battery pack 10 according to one embodiment of the present invention, an extension unit 300 may satisfy Mathematical Formula 2 below. When the extension unit 300 satisfies Mathematical Formula below, it may be more advantageous when discharging a gas G but preventing internally generated flames from being exposed to the outside.

$${L}_{G} > {L}_{U} \qquad [ Mathematical Formula 2 ]$$

In Mathematical Formula 2, L_{U} refers to the straight line distance between the first access passage 331 and the second access passage 332, and L_{G} refers to the length of the extension passage 320.

In the above, the first access passage 331 and the second access passage 332 each have a width in a horizontal direction in which a gas G flows, and the straight line distance shown when connecting each of the points corresponding to ½ of the width may be referred to as L_{U}. Referring to FIG. 3, L_{U} may be confirmed. In addition, the length of an extension passage 320 may refer to a shortest distance in which a gas G flowing into the extension passage 320 moves.

Referring to FIG. 3, in a battery pack 10 according to one embodiment of the present invention, an extension unit 300 may include one or more partition walls 340. In addition, there may be a plurality of partition walls 340. In other words, in the battery pack 10, an extension unit 300 may include a plurality of partition walls 340.

Referring to FIG. 3, the partition wall 340 may be connected to an extension frame 310. The partition wall 340 and the extension frame 310 may be in contact with each other and may include holes at appropriate positions corresponding to each other to be connected with bolts and nuts at the holes. In addition, the partition wall 340 and the extension frame 310 may be connected through an adhesive or welding. In addition, the partition wall 340 may be a part of an extension frame 310, and an extension frame 310 provided with the partition wall 340 may be manufactured through a method such as extrusion. In addition, the partition wall 340 may be coupled and fixed to an extension frame 310, and here, being coupled and fixed may mean that they are connected and fixed while being in contact with each other. The extension unit 300 may disrupt passing of a gas G through a partition wall 340. Since the partition wall 340 disrupts passing of a gas G, a path of the gas G may be lengthened, through this, it may be more advantageous when discharging a gas G but preventing internally generated flames from being exposed to the outside.

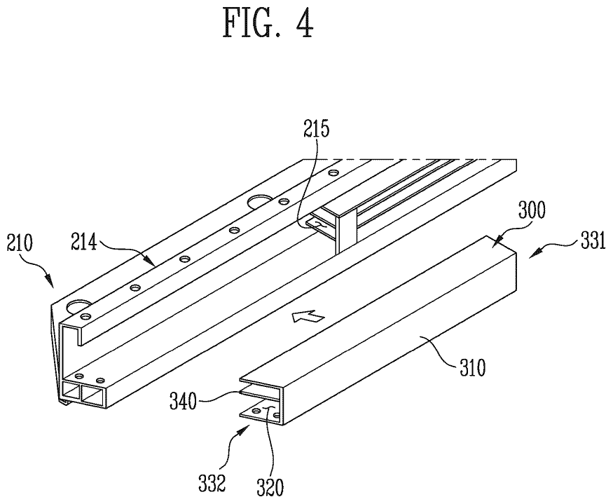

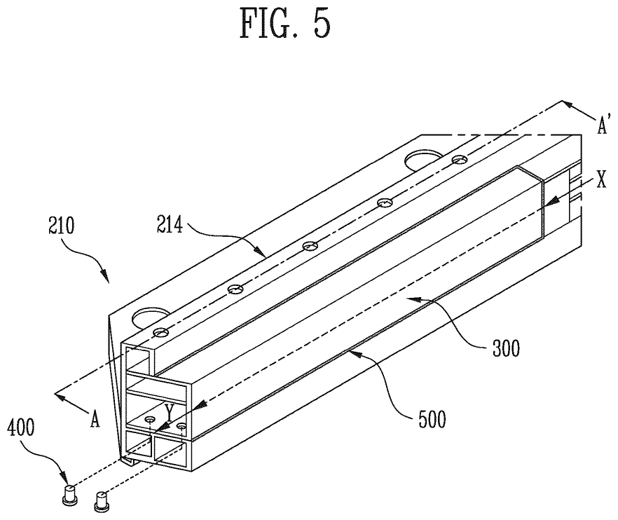

FIG. 4 is a diagram briefly showing an outer frame 210 and an extension unit 300 of a battery pack 10 according to one embodiment of the present invention. Referring to FIG. 4, the extension unit 300 may be coupled and fixed to a frame portion 200. Specifically, the extension unit 300 may be coupled and fixed to an outer frame 210 of a frame portion 200. The extension unit 300 may be in contact with a frame portion 200 with each other or may include holes at appropriate positions corresponding to each other to be coupled and fixed to a fixing portion 400 at the holes (see FIG. 5). Here, the hole may be formed on a partition wall 340. The fixing portion 400 may be bolts and nuts or the like. In addition, the extension unit 300 may be coupled and fixed to a frame portion 200 through an adhesive or welding.

In addition, the extension unit 300 may be provided within an inner passage 215 formed by a frame portion 200 or may be coupled and fixed to a frame portion 200 within the inner passage 215. Specifically, the extension unit 300 may be provided at least inside a support frame 214 or may be coupled and fixed to the support frame 214.

Although not shown in a drawing, in a battery pack 10 according to one embodiment of the present invention, an extension unit 300 may also be coupled and fixed to a cross member 220 of a frame portion 200 in the same manner as described above. In the following, the description about an outer frame 210 of a frame portion 200 and an extension unit 300 may also be applied to a cross member 220.

Referring to FIG. 4, an outer frame 210 of a frame portion 200 may provide an appropriate space so that an extension unit 300 may be inserted. The extension unit 300 may be allowed to approach the space, and the extension unit 300 may be coupled and fixed to a part of an outer frame 210 through the above-described fixing method.

FIG. 5 is a diagram briefly showing an outer frame 210 and an extension unit 300 of a battery pack 10 according to one embodiment of the present invention. Referring to FIG. 5, an extension unit 300 is coupled and fixed to an outer frame 210. The battery pack 10 illustrated in FIG. 5 couples and fixes the extension unit 300 and the outer frame 210 through a fixing portion 400 in the form of hardware (such as bolts and nuts). In another example, the fixing portion 400 may be an adhesive or a bead remaining after welding, and it is not particularly limited as long as it is used to coupled and fix the outer frame 210 and the extension unit 300. In other words, in the battery pack 10, an outer frame 210 and an extension unit 300 may be coupled through welding, an adhesive, or hardware fastening.

Referring to FIG. 5, a gas G generated from a battery cell unit 100 passes through an inner passage 215 and moves from point X to point Y. A gas G moving from point X moves to point Y through an extension passage 320 of an extension unit 300 in communication with an inner passage 215. In FIG. 5, the path of the gas G passing through an extension passage 320 of the extension unit 300 is marked by a dotted arrow. The extension unit 300 may lengthen the path of the gas G, and the above-described structure may prevent flames from being exposed to the outside.

A battery pack 10 according to one embodiment of the present invention may further include a sealing material 500. The sealing material 500 may be positioned at an area where an extension unit 300 and a frame portion 200 are coupled to each other. Specifically, the sealing material 500 may be positioned at an area where an extension unit 300 is coupled to an outer frame 210 of a frame portion 200 or a cross member 220 with each other. In addition, 320 by being positioned in the coupled area, the sealing material 500 may prevent a gas G passing through an extension passage 320 from moving through a path other than the extension passage 320. In addition, the sealing material 500 may allow an extension unit 300 and a frame portion 200 to adhere more closely to each other.

The sealing material 500 may include one or more selected from the group consisting of commonly used structural adhesives and liquid (at room temperature) gaskets. By using an appropriate material as the sealing material 500, a gas G may be prevented from leaking through an area where the extension unit 300 and the frame portion 200 are coupled to each other.

In a battery pack 10 according to one embodiment of the present invention, the extension unit 300 may include a material having a melting point of 550° C. or higher. The melting point of the material may be 560° C. or higher, 570° C. or higher, 580° C. or higher, 590° C. or higher, 600° C. or higher, 610° C. or higher, 620° C. or higher, 630° C. or higher, 640° C. or higher, 650° C. or higher, or 660° C. or higher. Since the higher the melting point of the material, the more advantageous, the upper limit is not particularly limited, but may be 3,000° C. or lower, 2,800° C. or lower, 2,600° C. or lower, 2,400° C. or lower, 2,200° C. or lower, 2,000° C. or lower, 1,800° C. or lower, or 1,600° C. or lower.

In addition, the extension unit 300 may include one material that satisfies the melting point range, and in another example, it may include a plurality of materials that satisfy the melting point range. A material satisfying the melting point range may include, for example, one or more selected from the group consisting of aluminum, steel, and ceramics (e.g., mica, etc.).

The term ‘melting point,’ used in the present application, refers to a temperature at which a solid undergoes phase transition into a liquid under normal pressure conditions. When the melting point of a specific object is widely known (for example, the melting point disclosed in Non-Patent Document 1), that value may be referred to as the melting point used in the present application. Unless the melting point of the specific object is widely known, a melting point value of the specific object measured through a capillary method under normal pressure conditions may be referred to as the melting point used in the present application. As the capillary analysis method, the method disclosed in European Pharmacopoeia 2.2.14 Melting point method—Capillary method may be applied.

In a battery pack 10 according to one embodiment of the present invention, when an extension unit 300 uses a material having a melting point in the above range, it may not be easily melted even by the heat due to a thermal runaway phenomenon and continuously provide an extension passage 320, thereby discharging a gas G but preventing flames from being exposed to the outside.

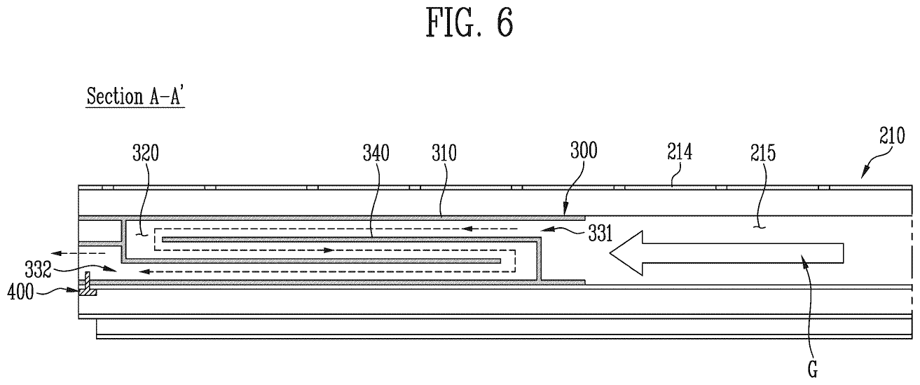

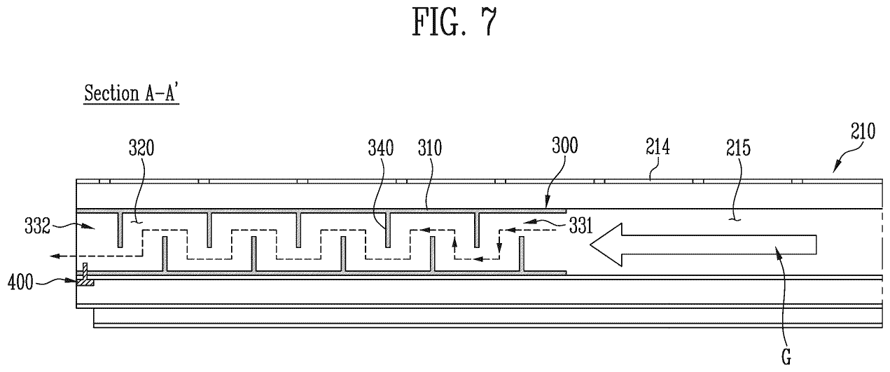

FIG. 6 shows a cross-section taken along line AA′ in FIG. 5 and is a diagram briefly showing an outer frame 210 and an extension unit 300 of a battery pack 10 according to one embodiment of the present invention. FIG. 7 shows an example different from FIG. 6 and is a diagram briefly showing an outer frame 210 and an extension unit 300 of a battery pack 10 according to one embodiment of the present invention.

The shape of the extension passage 320 of the extension unit 300 is not particularly limited as long as a discharge path of a gas G is lengthened in order to discharge a gas G but prevent internally generated flames from being exposed to the outside.

Referring to FIG. 6, a gas G passing through an inner passage 215 may approach an extension unit 300, and the gas G may passes through a first access passage 331 of the extension unit 300 to flow into a second access passage 332 along an extension passage 320 formed by a partition wall 340. The gas G that has flowed into the second access passage 332 may re-enter into the inner passage 215, and the gas G may be discharged to the outside through a communication hole 213. Referring to FIG. 6, the partition wall 340 is disposed to face an extension frame 310, and the movement path of the gas G is lengthened as the movement direction of the gas G changes into a left-and-right direction.

Referring to FIG. 7, a gas G passing through an inner passage 215 may approach an extension unit 300, and the gas G may passes through a first access passage 331 of the extension unit 300 to flow into a second access passage 332 along an extension passage 320 formed by a partition wall 340. The gas G that has flowed into the second access passage 332 may re-enter into the inner passage 215, and the gas G may be discharged to the outside through a communication hole 213. Referring to FIG. 7, the partition wall 340 is disposed to be vertical to an extension frame 310, and the movement path of the gas G is lengthened as the movement direction of the gas G is changed by the partition wall 340.

FIG. 8 is a diagram briefly showing a cross-section of a battery pack 10 according to one embodiment of the present invention. FIG. 9 is a diagram briefly showing a part of a cross-section of a battery pack 10 according to one embodiment of the present invention.

Referring to FIG. 8, a thermal runaway phenomenon may occur in a battery pack 10 according to one embodiment of the present invention. In FIG. 8, a battery cell unit 100T in which a thermal runaway phenomenon has occurred simultaneously discharges a large amount of gas G and particles as well as flames. Here, the gas G and at least a part of the particles may flow into an inner passage 215 through the above-described discharge hole 110. The gas G increases the pressure of an internal passage 215, and when the pressure becomes high enough to go out of a battery pack 10, the gas G may be discharged to the outside through a communication hole 213. Before the gas G is discharged to the outside through a communication hole 213, it passes through an extension unit 300 provided with an extension passage 320 in communication with an inner passage 215. In addition, not only the gas G but also flames pass through an extension unit 300, and the flames may be prevented from being exposed to the outside by an extension passage 320 of an extension unit 300 having a lengthened path. In FIG. 8, the path of the gas G passing through an extension passage 320 of an extension unit 300 is marked by a dotted arrow. Referring to FIG. 8, in a battery pack 10 according to one embodiment of the present

invention, an extension unit 300 may be positioned at an area between a communication hole 213 (H₁) and an adjacent discharge hole 110 (H₂), which is a discharge hole 110 positioned closest to the communication hole 213 (H₁) along an inner passage 215. Since the extension unit 300 is positioned in the above-described area, even when a thermal runaway phenomenon occurs in a battery cell unit 100 that is relatively close to a communication hole 213, risks caused by a large amount of gas G may be prevented, and flames may be prevented from being exposed to the outside.

Referring to FIG. 9, a thermal runaway phenomenon may occur in a battery pack 10 according to one embodiment of the present invention. In FIG. 9, a battery cell unit 100T in which a thermal runaway phenomenon has occurred simultaneously discharges a large amount of gas G and particles as well as flames. Here, the gas G may flow into an inner passage 215 through the above-described discharge hole 110. In addition, the gas G may flow into a cross passage 222 through the above-described discharge hole 223, and the gas G that has flowed into the cross passage 222 may flow into an inner passage 215 through the above-described discharge hole 224. The gas G increases the pressure of an internal passage 215, and when the pressure becomes high enough to go out of a battery pack 10, the gas G may be discharged to the outside through a communication hole 213. Before the gas G is discharged to the outside through a communication hole 213, it passes through an extension unit 300 provided with an extension passage 320 in communication with an inner passage 215. In addition, not only the gas G but also flames pass through an extension unit 300, and the flames may be prevented from being exposed to the outside by an extension passage 320 of an extension unit 300 having a lengthened path. Although not shown in a drawing, the extension unit 300 may also be formed at a cross member 200. In FIG. 9, the path of the gas G passing through an extension passage 320 of an extension unit 300 is marked by a dotted arrow.

Referring to FIG. 9, in a battery pack 10 according to one embodiment of the present invention, an extension unit 300 may be positioned at an area closer to a communication hole 213 (H₁) than to an adjacent discharge hole 110 (H₂). In addition, in the battery pack 10, an extension unit 300 may be positioned at an area that satisfies Mathematical Formula 3 below.

$${L}_{2} > {L}_{1} \qquad [ Mathematical Formula 3 ]$$

In Mathematical Formula 3, L₁ refers to the distance along the internal passage 300 between the extension unit and the communication hole 213 (H₁), and L₂ refers to the distance along the internal passage 215 between the extension unit 300 and the adjacent discharge hole 110 (H₂). Referring to FIG. 9, when it is assumed to move from a communication hole 213 (H₁) through an internal passage 215, L₁ may refer to the distance to the point where an extension unit 300 is reached. In addition, referring to FIG. 9, when it is assumed to move from an adjacent discharge hole 110 (H₂) through an internal passage 215, L₂ may refer to the distance to the point where an extension unit 300 is reached.

Since the extension unit 300 is positioned in the above-described area that satisfies Mathematical Formula 3, even when a thermal runaway phenomenon occurs in a battery cell unit 100 that is relatively close to a communication hole 213, risks caused by a large amount of gas G may be prevented, and flames may be prevented from being exposed to the outside.

Meanwhile, the battery pack 10 according to one embodiment of the present invention may include a sealing portion sealing a communication hole 213. The sealing portion normally seals an internal passage 215 so that it is not in communication with the outside, but when a significant amount of gas G formed by a thermal runaway phenomenon or the like flows into the internal passage 215, it allows the gas G in the internal passage 215 to be discharged to the outside. The sealing portion may be a valve or a stopper. In other words, the sealing portion may be naturally removed due to a high pressure of an internal passage 215 or the seal may be released by automatic or manual operation, thereby allowing the gas G in the internal passage 215 to be discharged to the outside.

An electric device according to one embodiment of the present invention may include one or more battery packs 10 according to one embodiment of the present invention. The above-described electric device refers to a device that is operated using power generated from battery cells or the like. The electric device may be, for example, a mobile phone, a home appliance, an electric vehicle, a hybrid vehicle, or an energy storage system (ESS).

What is claimed is:

1. A battery pack comprising:
one or more battery cell units;
a frame portion including an outer frame surrounding an inner space in which the battery cell units are installed; and
an extension unit provided at a partial area of the frame portion,
wherein the outer frame includes a support frame, an inner passage which is formed by being surrounded by the support frame and through which a gas may pass; and a communication hole communicating the inner passage and the outside of the outer frame, and
the extension unit includes an extension frame and an extension passage through which the gas may pass, wherein the extension passage which is formed by being surrounded by the extension frame and which is in communication with the internal passage with each other.

2. The battery pack according to claim 1, satisfying Mathematical Formula 1 below:
$$T \leq {T}_{A} \qquad [ Mathematical Formula 1 ]$$
wherein in Mathematical Formula 1, T refers to the temperature (unit: ° C.) measured in the communication hole when the temperature (T_{I}) of the battery cell unit is 200° C. or higher, and T_{A} refers to 800° C. as a reference temperature.

3. The battery pack according to claim 2, wherein the temperature (T_{I}) of the battery cell unit is 200° C. or higher, and
a ratio (T/T_{I}) of the temperature (T, unit: ° C.) measured in the communication hole to the temperature of the battery cell unit (T_{I}, unit: ° C.) is within a range of 0.1 to 0.7.

4. The battery pack according to claim 1, wherein the extension unit is provided at a partial area of the outer frame.

5. The battery pack according to claim 1, wherein the extension unit further includes a first access passage and a second access passage formed such that the extension passage and the inner passage communicate with each other, and wherein the first access passage and the second access passage face each other, and the first extension satisfies Mathematical Formula 2 below:
$${L}_{G} > {L}_{U} \qquad [ Mathematical Formula 2 ]$$
In Mathematical Formula 2, L_{U} refers to the straight line distance between the first access passage and the second access passage, and L_{G} refers to the length of the extension passage.

6. The battery pack according to claim 5, wherein the extension unit further includes one or more partition walls, and
wherein the partition wall is connected to the extension frame and is configured to disrupt passing of a gas.

7. The battery pack according to claim 6, wherein the extension unit further includes a plurality of partition walls.

8. The battery pack according to claim 1, wherein the extension unit is coupled to the frame portion.

9. The battery pack according to claim 1, wherein the extension unis includes a material with a melting point of 550° C. or higher.

10. The battery pack according to claim 1, wherein at least a part of the battery cell unit is in contact with the outer frame, and at least a part of the contacted area of the battery cell unit and the outer frame includes a discharge hole in communication with the inner passage,
and a gas generated from the battery cell unit flows into the inner passage through the discharge hole.

11. The battery pack according to claim 10, wherein the extension unit is positioned at an area between a communication hole (H₁) and an adjacent discharge hole (H₂), which is a discharge hole positioned closest to the communication hole along the internal passage.

12. The battery pack according to claim 11, wherein the extension unit satisfies Mathematical Formula 3 below:
$${L}_{2} > {L}_{1} \qquad [ Mathematical Formula 3 ]$$
In Mathematical Formula 3, L₁ refers to the distance along the internal passage between the extension unit and the communication hole (H₁), and L₂ refers to the distance along the internal passage between the extension unit and the adjacent discharge hole (H₂).

13. The battery pack according to claim 1, wherein the frame portion further includes one or more cross members crossing the inner space, and at least a part of the battery cell unit is in contact with the cross member.

14. The battery pack according to claim 13, wherein the cross member is bonded and fixed to the outer frame, wherein the cross member includes a support member and a cross passage which formed by being surrounded by the support member and through which a gas may pass,
wherein at least a part of the area in which the battery cell unit is in contact with the cross member includes a discharge hole in communication with the cross passage, and
wherein a gas generated from the battery cell unit flows into the cross passage through the discharge hole.

15. The battery pack according to claim 14, wherein the inner passage of the outer frame is in communication with the cross passage of the cross member with each other.

16. The battery pack according to claim 8, further comprising a sealing material, wherein the sealing material is positioned at an area in which the extension unit and the frame portion are coupled with each other.
